(19) United States
(12) Patent Application Publication
(10) Pub. No.: US 2016/0156108 A1
(43) Pub. Date: Jun. 2, 2016

(54) MEANDER LINE CIRCULAR POLARISER

(71) Applicant: THE SECRETARY OF STATE FOREIGN & COMMONWEALTH AFFAIRS, Cheltenham (GB)

(72) Inventors: KEVIN PAUL THOMAS, CHELTENHAM (GB); IVOR LESLIE MORROW, SHRIVENHAM (GB)

(21) Appl. No.: 14/901,401

(22) PCT Filed: Jul. 9, 2014
(86) PCT No.: PCT/GB2014/000277

§ 371 Date: Dec. 28, 2015

(30) Foreign Application Priority Data
Jul. 9, 2013 (GB) GB1312282.5
Jul. 24, 2013 (GB) GB1313236.0

(51) Int. Cl. H01Q 15/24

(52) U.S. Cl. CPC H01Q 15/244

(57) ABSTRACT

A wideband meander-line circular polariser includes a substrate and a plurality of parallel meander shaped conductors (meander lines). Each parallel meander line (20,30) is loaded with electrically isolated capacitive elements (40) enclosed within some or all of the individual meander loops, allowing the polariser to be made electrically smaller for a given wavelength whilst maintaining the desired resonant frequency. Multiple layers of the device ma be used.

### BACKGROUND TO THE INVENTION

This invention relates to a meander line circular polariser suitable for use as components of antennae.

The need to reduce the size, weight and improve the performance of circular polarisers suitable for use in antennae, has many benefits for military and commercial applications.

In the military arena, the modern soldier is equipped with multiple devices, including combat net radio, personal role radio, GPS receiver, hand-held satellite communications (SATCOM) antenna, enhanced position location reporting system (EPLRS), blue force tracker (BFT) to name a few. A defence command and control vehicle platform may have numerous systems running simultaneously, ranging from multiple HF, VHF, UHF communications, tactical satellite (TACSAT) communications, remotely operated video enhanced receivers (ROVER), unmanned aerial platforms (UAV) using Ka and Ku band controller, WiFi data telemetry systems.

In the civil sector the general populous may carry a smart phone consisting of antennae for WiFi, Bluetooth and sometimes up to, two antennas (MIMO) to access the mobile network. An individual could be transferring a file via Bluetooth and simultaneously downloading data over the mobile network and at the same time hosting a WiFi hotspot.

In all these examples there are a number of common features and future antenna emerging trends; specifically, space and power are limited, moderate to high gain is necessary, wide bandwidth and simultaneous operation with space, frequency and also polarization diversity without interference is becoming essential.

In a communication channel, a signal undergoes many different end-to-end losses. One such loss can be attributed to the polarization mismatch between the transmitting and receiving antennas. For example, in ground-to-ground communications the polarization of a signal could change due to a reflection of a surface. This could cause a vertically polarized antenna to receive a signal that is polarized at a slant. The vertically polarized antenna will not be able to capture all the energy from the signal, resulting in polarization mismatch losses. In ground-to-space applications, it is almost impossible to predict the orientation of the linearly polarized signal for two reasons, specifically, the amount of Faraday rotation caused by the ionosphere is difficult to estimate and the orientation of the space vehicle may not be known. The known solution to all these problems is to use circular polarization.

Circular polarization eliminates the need to correctly orientate the transmitting and receive antennas. The rotation of a circularly polarized signal ensures that the antenna can maximizes the capture of energy.

The need to create and receive a polarized signal through spectral modification has been the subject of much previous work. Spectral modification relates to the modification of the spectral radiation signature of a surface in absorption reflection or transmission through patterning a surface with a periodic array of electrically conducting elements or with a periodic array of apertures in an electrically conducting sheet. Spectral modifications using such structures have been readily shown in literature to be configured so that a spectral filter function is performed, additionally such structures are also shown to perform a polarization filter function and are known as Frequency Selective Surfaces (FSS).

One such known FSS is a meander line FSS. The geometry of the meander lines and spacing between them determines the frequency response of the surface. Single layer meander lines are however limited in their performance, they cannot transmit or receive wide bandwidth signals and they cannot be made electrically small without degrading both bandwidth and performance.

### SUMMARY OF THE INVENTION

The present invention provides a meander line circular polariser having two or more elongated conducting members mounted parallel to each other in the same direction on one surface of a planer non-conducting support, each conducting member being folded in alternating directions transverse to its direction of mounting in the shape of multiple meander loops, wherein separate conducting members are mounted on the support within adjacent meanderloops of the elongated conducting members and in electrical isolation therefrom, the planer non-conducting support, the elongated conducting members and the separate conducting members together forming a frequency selective surface.

The presence of electrically-isolated separate conducting members within the loops of the meander line conducting members introduces additional capacitance to the polariser in a manner which allows the polariser to be made electrically smaller for a given operating wavelength while maintaining the desired resonant frequency. A wide bandwidth of operation may also be achived without necessitating the introduction of multiple, spaced FSS arrays.

### BRIEF DESCRIPTION OF THE DRAWINGS

FIG. 1 is a pattern view of a section of an embodiment of the present invention

FIG. 1a is an end view of the embodiment illustrated in FIG. 1

FIG. 2 is a pattern view of a repeat cell of the embodiment illustrated in FIG. 1

FIG. 3 shows an equivalent transmission line model for parallel propagation along the surface of a conventional single layer meander line antenna

FIG. 4 shows an equivalent transmission line model for perpendicular propagation along the surface of a conventional single layer meander line antenna

FIG. 5 shows an equivalent transmission line model for parallel propagation along the surface of a single layer meander line antenna according to the present invention

FIG. 6 shows an equivalent transmission line model for perpendicular propagation along the surface of a single layer meander line antenna according to the present invention

FIG. 7 is a pattern view of a repeat cell of alternative embodiment to that illustrated in FIG. 1,

### DETAILED DESCRIPTION OF THE EMBODIMENT

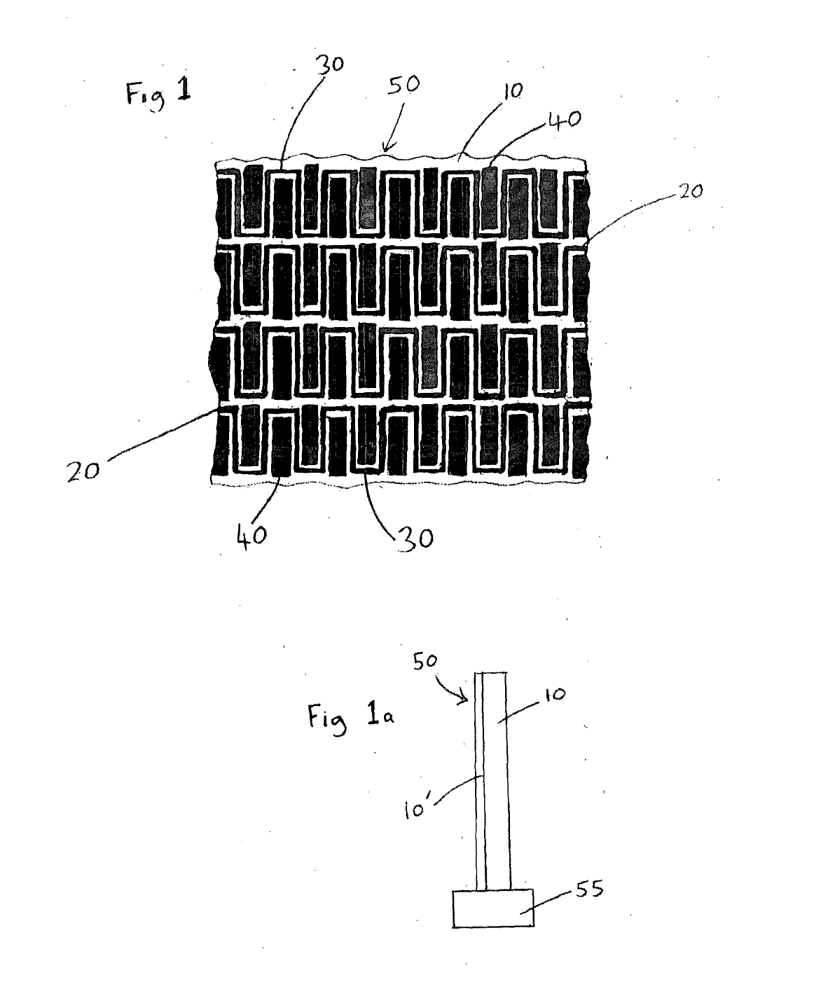

The embodiment illustrated in FIGS. 1 and 1a consists of a planar electrically non-conducting substrate 10 having a planar surface 10′ onto which is bonded a series of parallel, meander-shaped conducting strips 20 (four are shown on the section of substrate illustrated). The substrate 10 provides the strips 20 with mechanical strength and may be of a conventional dielectric material such as Taconic RF-35 or a semiconductor material such as a silicon wafer. A series of loops 30 is defined by the meander-shaped conducting strips 20, within each of which is located a short strip 40 of conducting material also bonded to the planar surface 10′. The short strips 40 are positioned so that they are electrically isolated from the meander line conducting strips 20. The strips 20 and 40 are made of the same material e.g. copper sheet and together with the planar electrically non-conducting substrate 10 they form a frequency selective surface (FSS) 50. The strips 20 and 40 can be formed on the substrate surface 10′ by conventional milling or lithographic screen printing PCB fabrication techniques. The strips 20 and 40 bonded to the substrate 10 are together conveniently mounted on a linear stand 55 which allows the FSS to be supported at any required angle.

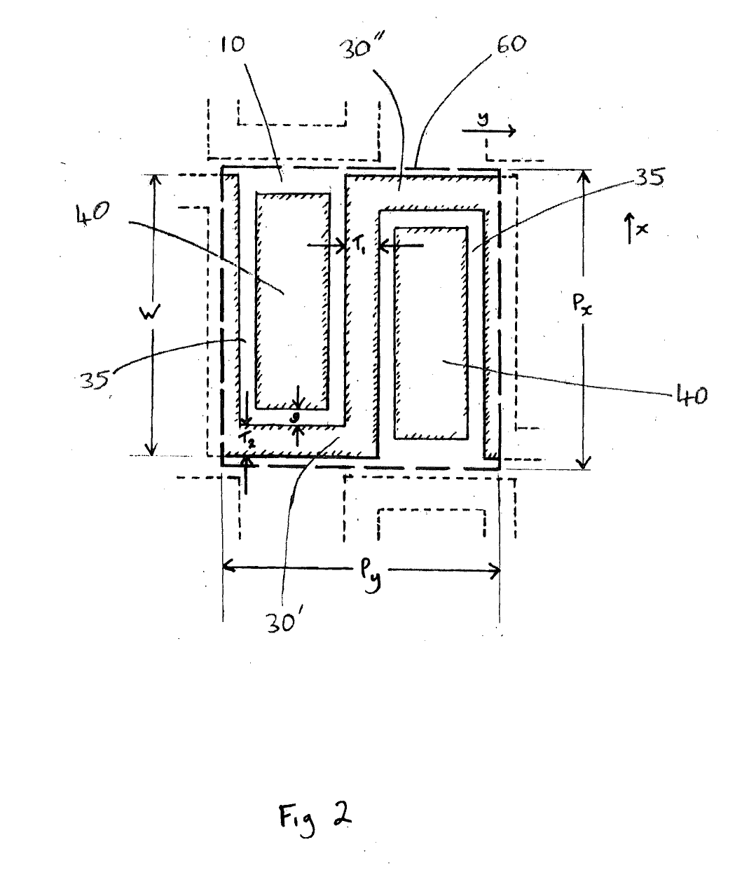

The FSS 50 is in effect comprised of a periodic array of unit cells 60 one of which is illustrate in FIG. 2. The cell 60 consists of two adjacent loops 30′ and 30″ of the conducting strips 20 extending each in laterally-opposing directions to the other. The spaces 35 defined by adjacent arms of each loop are each occupied by a strip 40 separated in electrical isolation from the conductor 20 on the substrate surface 10′ by a gap g. The cell 60 is further characterised as having a width W (which is also the average distance between, adjacent strips 20), periodicity in the x-direction (unit cell size) Pₓ, periodicity in the y-direction P_{y}, and a meander line thickness of T1 and T2 in the y- and x- direction, respectively.

In operation, the unit cell 60 is excited by a linearly polarized plane wave rotated by 45°. This element type will perform similarly to known single-layer meander line polarizer, with the key advantage of being electrically much smaller.

An explanation of the function of this invention requires a review of the transmission analysis technique for a conventional single-layer meander line polariser. An equivalent lumped model for the meander line polariser according to the present invention can then be introduced, which places in context the choice for its unique geometry while concurrently demonstrating how it differs electrically from known meander line polarisers, and explaining how this achieves a much smaller unit cell size and wide bandwidth.

In a known single layer meander line polariser, it can be assumed that a single layer surface presents a shunt inductance in the parallel direction and shunt capacitance in the perpendicular direction. To produce a circular polarised signal the phase of the parallel component, θ_{||}, would need to be phase advanced by 45° (inductive) and the phase of the perpendicular component, θᵢ, would need phase retarded by 45°. The total differential phase shift will therefore be 90°.

As the phase of each component is increased the reflection magnitude of the reflection coefficient, Γ, also increases. This reflection coefficient ideally should be to zero, but this is only possible when the phase is at 0°. Exactly half the energy is reflected (3 dB insertion loss) meaning only the remaining half of the total energy will be transmitted. Hence from a fundamental physics perspective it is not possible to design a lossless single layer polarisation converter, and multiple layers would need to be used.

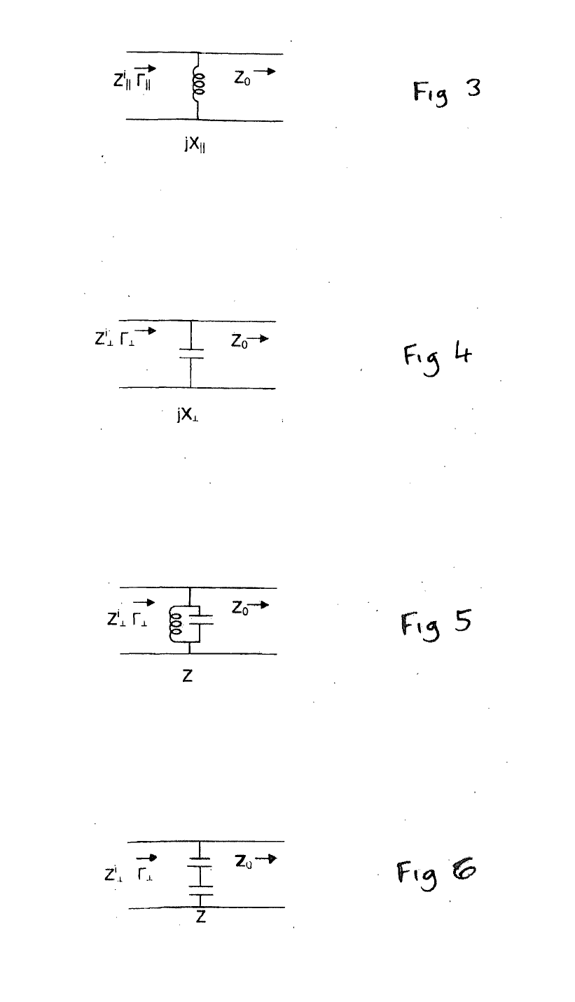

It can be assumed that a surface is inductive for parallel propagation and capacitive for perpendicular propagation. The equivalent transmission line model for parallel propagation is shown in FIG. 3. The relationship between the integers shown in FIG. 3 can be defined by the following equation (Eq-1).

$${Z}_{\vert \vert}^{i} = \frac{{jX}_{\vert \vert} {Z}_{0}}{{jX}_{\vert \vert} + {Z}_{0}} \qquad ( Eq \text{-} 1 )$$

where Z₀ is the impedance of free-space. The equivalent transmission line model for perpendicular propagation is shown in FIG. 4 below. The relationship between the integers shown in FIG. 4 can be defined by the following equation (Eq-2).

$${Z}_{⊥}^{i} = \frac{- {jX}_{⊥} {Z}_{0}}{- {jX}_{⊥} + {Z}_{0}} \qquad Eq \text{-} 2 )$$

The impedance of both components can be deduced from a Smith chart and the capacitive reactance and inductance determined. Generalised equations for capacitance and inductance can then be used to estimate the geometric parameters of the element. The analysis pertains only to the dominant transverse electric (TE) and transverse magnetic (TM) modes and assumes all higher Floquet modes are evanescent. Thus this model only provides a starting point and the detailed design would then need to be performed using full wave analysis techniques.

It is known that a multi-layer surface allows for broader bandwidth and lower losses due to reflection (Munk, B. A., 2003. Finite Antenna Arrays and FSS, 1st ed. Wiley-IEEE Press). This is because the angle of the transmission coefficient can be reduced, resulting in higher transmission. For example, in a three layer model the transmission angle for each layer is normally selected to be 11.25°, 22.5° and 11.25°. Clearly, this will reduce the magnitude of reflection. In order to rotate the impedance so that it remains close to real at the surface of the next layer, an adequate spacing beween layers is required. Although the overall performance is improved by using a multi-layer design, the overall electrical thickness will be increased. This can be reduced somewhat by filling the space with a high permittivity, low loss dielectric, but at low frequencies, the walls of the dielectric will become very thick.

For a meander line model in accordance with the present invention, the transmission line equivalent circuit for the parallel direction is shown in FIG. 5.

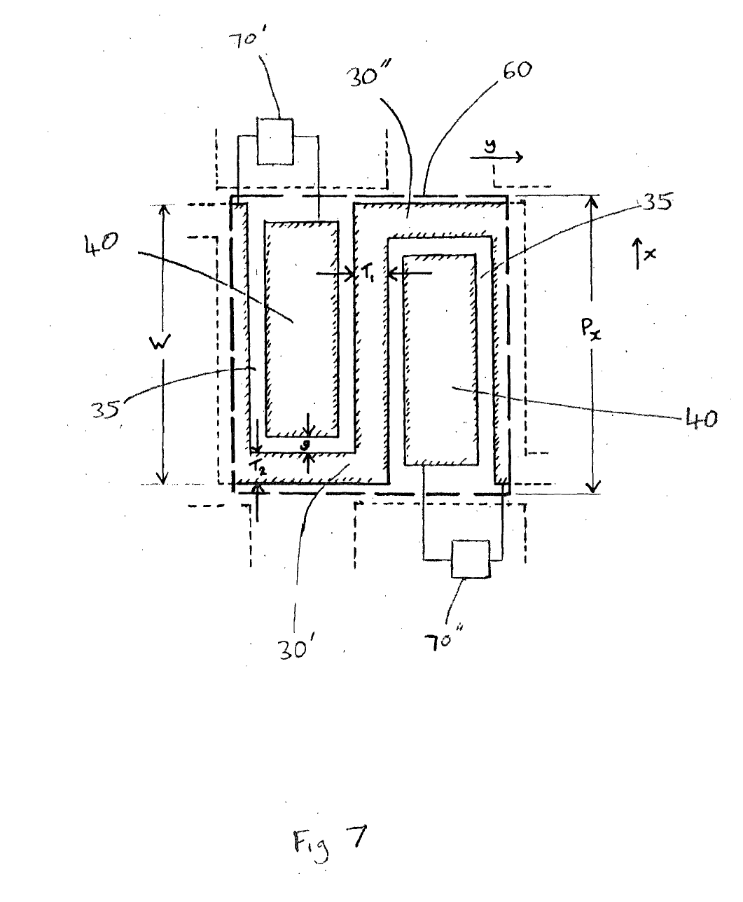

According to Eqn 1 and 2 above, as the product of LC (inductance multiplied by capacitance) becomes smaller the resonant frequency increases. By loading the parallel, meander-shaped conducting strips 20 with additional capacitance in the form of the short strips 40 of conducting material, the resonant frequency of the meander line polariser increases. The equivalent transmission line model is shown in FIG. 6 below for the perpendicular direction when W<Pₓ, which means there is a gap between adjacent meander-shaped conducting strips.

Although modelled similar to a known meander line configuration, the additional loading attributed to the short metal strips 40 adds another capacitance in series, which has the effect of reducing the overall capacitance. This additional capacitance can be attributed to the proximity of adjacent meander lines. This additional capacitance can be attributed not only to the proximity of the short metal strips 40 to the conducting strips 20 by their location within the meander line loops, but also by the, ability to bring adjacent meander-shaped conducting strips 20 into closer proximity to each other. Once again, according to Eqns 1 & 2, reducing the capacitance causes the resonant frequency to increase.

The insertion of short metal strips 40 into the meander network allows for an electrically small (≦λ/2π) unit cell or element size to be realized, where λ is the network's nominal operating wavelength. This size reduction can be enhanced through very tight coupling resulting from maximizing the surface capacitance areas (areas of the short metal strips 40) and inductive line thickness (T1 and T2). The capacitance effect is further enhanced by the presence of the supporting substrate 10 where this is of a dielectric material. This structure provides a further advantage in that it gives a wider bandwidth over known single layer meander line polarisers that would conventionally give a much narrower bandwidth. The 3 dB bandwidth can span 50% BW and is very wideband for a single layer polarizer.

This wideband tightly coupled LML is new to meanderline technology and not taught science or art. It is apparent that the insertion of the metal strips has also resulted in a single layer wideband design which hitherto has not been reported.

The following defines the effects of each parameter where W in FIG. 2 is set to approximately λ/4 and periodicity, Pₓ, is set to λ/2. This produces a phase shift of about 90°. The table below summaries the effect each parameter has on the various outputs. It should be read as though the subject parameter is being increased.

TABLE 1
Summary of parameters and their effects

| Parameter | Resonant | Phase | |
|---|---|---|---|
| (increased) | Frequency | Parallel | Perpendicular |
| Gap, g | increases | 0-phase decreases | decreases |
| Length, Py | slightly decreases | 0-phase decreases | increases |
| Periodicity, Px | increases | slightly decreases | increases |
| Thickness, T1 | slightly increases | increases | slightly decreases |
| Thickness, T2 | decreases | Increases | slightly increases |
| Width, W | decreases | decreases | slightly decreases |

The design parameters indicate that an optimised meander line polarisation converter in accordance with the present invention is made up of unit cell each with a size (Pₓ×P_{y}) of from λ²/50 to λ²/200 at the converter's nominal operating wavelength λ, with a units cell size of between λ²/120 and λ²/170 being particularly advantageous. Due to symmetry the FSS should produce right-hand circular polarisation (RHCP) or left-hand circular polarisation (LHCP), depending on the orientation of the incident linear polarised field.

The present polariser when integrated with a Fabry-Perot cavity was found to perform much as expected in accordance with the analysis described above. Analysis of simulation experiments indicated the resonance condition is sensitive to the fine column array gap spacing parameter. For this reason between 75 and 98% of the area enclosed within each meander loop is occupied by one of the short strips. However, most modern milling or lithographic screen printing PCB fabrication techniques are capable of meeting this precision.

In a further embodiment of the invention illustrated in FIG. 7, each short strip 40 is connected to its adjacent loop 30′, 30″ of meander-shaped conducting strip 20 through a MEMS device 70′, 70″ (shown schematically), providing two such devices per unit cell. This allows for active reconfiguration of the unit cell, to switch the operating frequency in discrete steps. Alternatively, embedding varicaps in place of the MEMS device can result in a continuously frequency control capability.

1. A meander line circular polariser having two or more elongated conducting members mounted parallel to each other in the same direction on one surface of a planer non-conducting support,
each elongated conducting member being folded in alternating directions transverse to its direction of mounting in the shape of multiple meander loops,
wherein separate conducting members are mounted on the support within adjacent meander loops of the elongated conducting members and in electrical isolation therefrom, the planer non-conducting support, the elongated conducting members and separate conducting members together forming a frequency selective surface.

2. A meander line circular polariser according to claim 1 wherein non-conducting support is made from a dielectric material.

3. A meander line circular polariser according to claim 1 wherein between 75 and 98% of the area enclosed within each meander loop is occupied by the separate conducting members.

4. A meander line circular polariser according to claim 1 wherein the average distance between adjacent elongated conducting members is ≦λ/2π where λ is the nominal operating wavelength of the polariser.

5. A meander line circular polariser according to claim 4 wherein the unit cell size comprising the area enclosed by two adjacent meander loops of the same elongated conducting member is from λ²/50 to λ²/200.

6. A meander line circular polariser according to claim 1 having a single layer of elongated conducting members and separate conducting members.

7. A meander line circular polariser according to claim 1 wherein the elongated conducting members and the separate conducting members are made from the same conducting material.

8. A meander line circular polariser according to claim 1 wherein the elongated conducting members and the separate conducting members are made from conducting metal forming a single layer on the substrate.

9. A meander line circular polariser according to claim 7 wherein the elongated conducting members and the separate conducting members are formed by selectively milling a metal-faced non-conducting support until the desired pattern of elongated conducting members and separate conducting members on the support are formed.

10. A meander line circular polariser substantially as hereinbefore described with reference to the drawings.
